(19) United States
(12) Patent Application Publication
(10) Pub. No.: US 2015/0107260 A1
(43) Pub. Date: Apr. 23, 2015

(54) GAS TURBINE AND GAS TURBINE AFTERBURNER

(71) Applicant: ClearSign Combustion Corporation, Seattle, WA (US)

(72) Inventors: JOSEPH COLANNINO, BELLEVUE, WA (US); IGOR A. KRICHTAFOVICH, KIRKLAND, WA (US); ROBERT E. BREIDENTHAL, SEATTLE, WA (US); CHRISTOPHER A. WIKLOF, EVERETT, WA (US)

(21) Appl. No.: 14/528,216

(22) Filed: Oct. 30, 2014

Related U.S. Application Data
(63) Continuation of application No. PCT/US2013/038962, filed on Apr. 30, 2013.
(60) Provisional application No. 61/640,692, filed on Apr. 30, 2012.

(51) Int. Cl. F02K 3/10; F02C 7/266

(52) U.S. Cl. CPC F02K 3/10; F02C 7/266
USPC 60/776; 60/39.281

(57) ABSTRACT

A gas turbine afterburner includes a gutter electrode that helps to hold an afterburner flame. A charge source applies a majority charge to be carried by a turbine exhaust gas. Electrical attraction between the majority charge and the gutter electrode helps to hold the afterburner flame.

### CROSS-REFERENCE TO RELATED APPLICATIONS

The present application is a U.S. Continuation Application which claims priority benefit under 35 U.S.C. §120 (pre-AIA) of co-pending International Patent Application No. PCT/US2013/038962, entitled “GAS TURBINE AND GAS TURBINE AFTERBURNER”, filed Apr. 30, 2013; which application claims priority benefit from U.S. Provisional Patent Application No. 61/640,692, entitled “HIGH VELOCITY COMBUSTOR”, filed Apr. 30, 2012; each of which, to the extent not inconsistent with the disclosure herein, is incorporated by reference.

### BACKGROUND

In gas turbine engines, an afterburner can be added to support an increase thrust for short periods. Afterburners are also referred to as “reheat systems” in the literature. Afterburners work by spraying fuel into hot exhaust gas exiting the final turbine stage of a gas turbine. The sprayed fuel is ignited to react with residual oxygen present in the exhaust gas from the final turbine stage. While afterburners are inefficient with respect to fuel consumption, they can increase thrust dramatically and are especially useful for increasing thrust at take-off or transonic transition (between about Mach 0.95 and Mach 1.2 to 1.7, for example). Afterburners can be particularly useful in military aircraft.

Afterburners use flame holders, also referred to as gutters, to hold the afterburner flame and prevent flame blow-out. Afterburner gutters in the prior art operate as bluff bodies that cause heat recycling into the fuel spray by the formation vortices formed on the trailing edge of the gutter.

### SUMMARY

An afterburner with reduced gutter size would be useful for decreasing aerodynamic drag and thereby increasing thrust produced by the afterburner or reducing fuel consumed by the afterburner.

According to an embodiment, a gas turbine afterburner includes a gutter configured as an aerodynamic bluff body to produce vortices in exhaust gas from the gas turbine, a charge source configured to apply a majority charge to the exhaust gas or the fuel, and a gutter electrode configured to attract the majority charge toward the gutter. By augmenting flame holding with the electrical attraction between the exhaust gas and the gutter electrode, the vortices can be formed to cause less parasitic pressure drop through the afterburner.

According to an embodiment, a method for operating a gas turbine afterburner includes applying a majority electrical charge to be carried by a hot exhaust gas, applying a holding voltage to a gutter electrode, and holding a flame in a gas turbine exhaust pipe with a combination of an aerodynamic gutter and an attractive force between the holding voltage applied to the gutter electrode and the majority charge carried by the hot exhaust gas.

### BRIEF DESCRIPTION OF THE DRAWINGS

FIG. 1A is a block diagram of a gas turbine with afterburner, according to an embodiment.

FIG. 1B is a combination perspective and block diagram view of the afterburner of FIG. 1A, according to an embodiment.

FIG. 2 is a sectional diagram of a portion of the afterburner of FIGS. 1A and 1B, according to an embodiment.

FIG. 3 is a diagram of the afterburner wherein the charge source includes a dielectric tube aligned to convey charged air into the exhaust gas, according to an embodiment.

FIG. 4 is a diagram of the gas turbine with afterburner of FIGS. 1A and 1B wherein the gutter and gutter electrode are formed integrally with one another, according to an embodiment.

FIG. 5 is a flow chart showing a method for using the gas turbine with afterburner, according to an embodiment.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

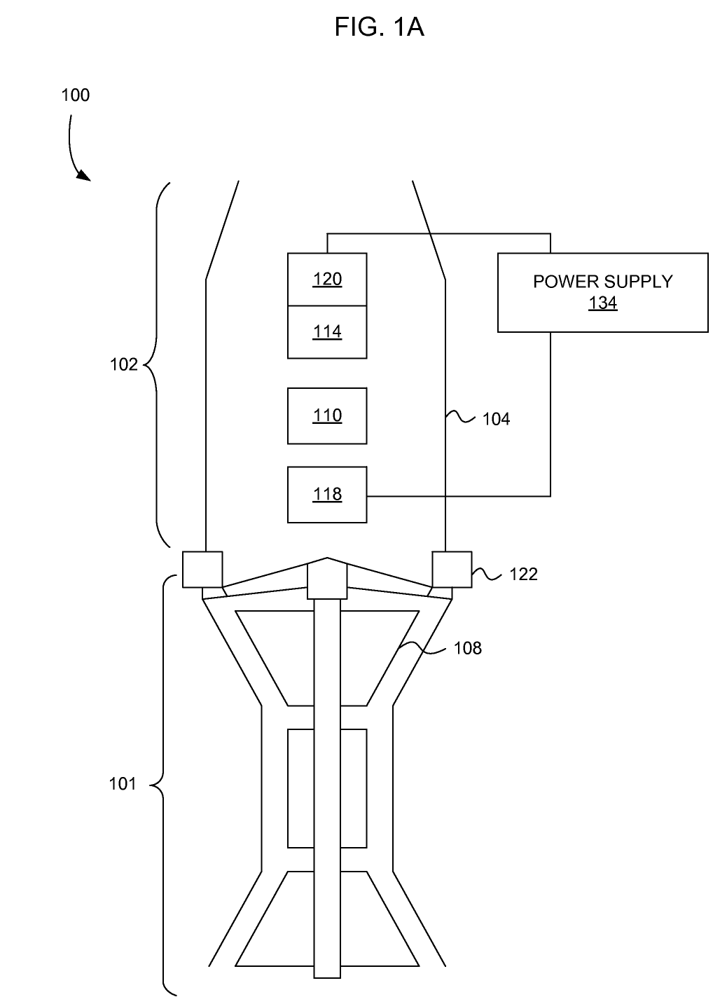

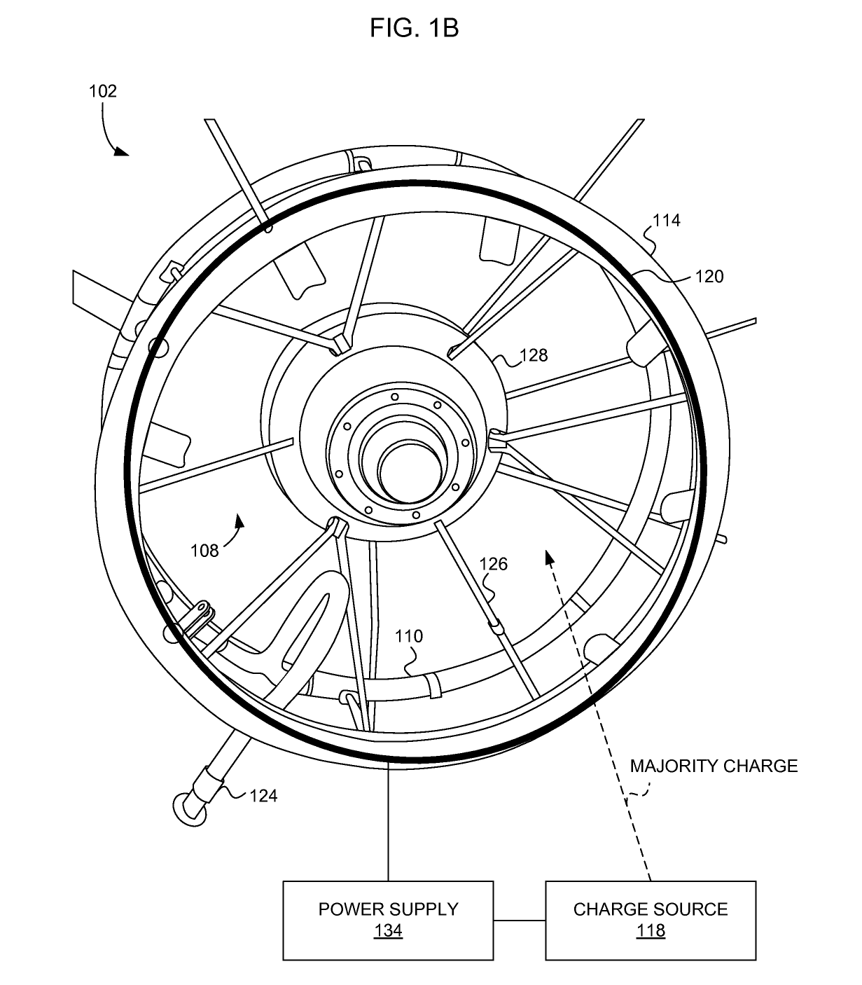

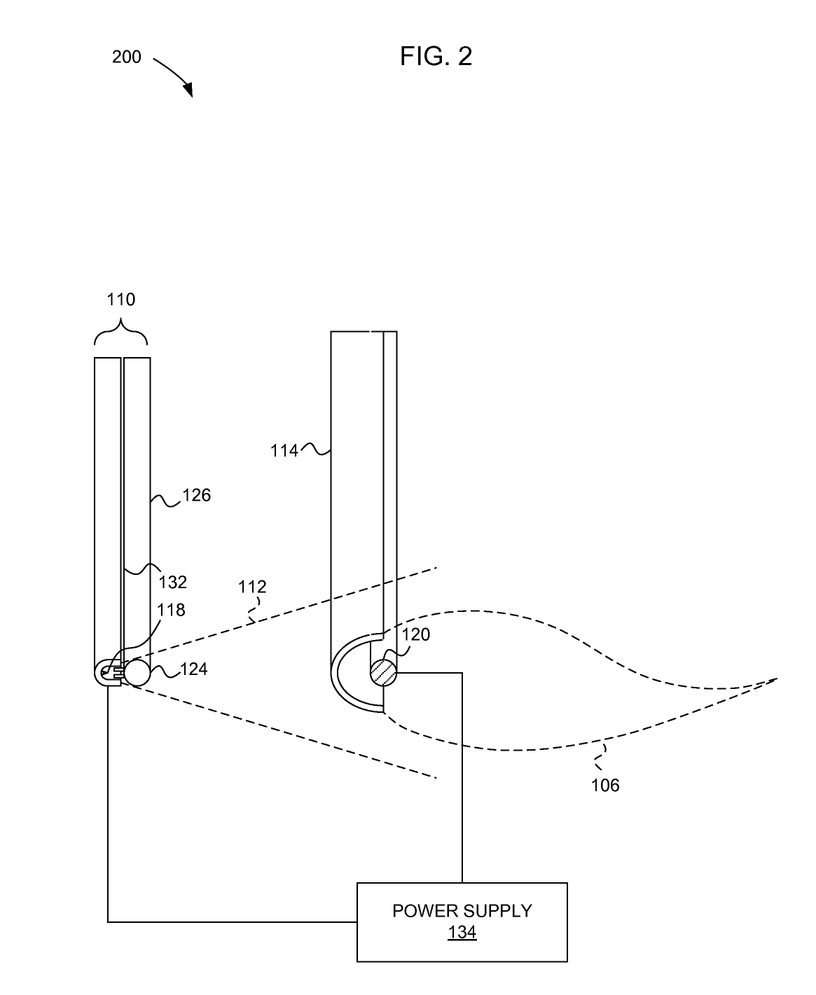

FIG. 1A is a block diagram of a gas turbine 100 including a turbine portion 101 and an afterburner 102, according to an embodiment. FIG. 1B is a perspective view of the afterburner 102 of FIG. 1A, according to an embodiment. FIG. 2 is a side sectional diagram of a portion of the afterburner 102 of FIGS. 1A and 1B, according to an embodiment 200. Referring to FIGS. 1A, 1B, and 2, a gas turbine 100 includes an afterburner 102 with an exhaust pipe 104 aligned to receive exhaust gas from a gas turbine stage 108. A fuel sprayer 110 is configured to spray fuel 112 into the exhaust gas. A gutter 114 is configured as an aerodynamic bluff body to produce vortices in the exhaust gas help in holding an afterburner flame 106. Compared to the prior art, the gutter 114 may be made to have a smaller frontal area and/or smaller in aerodynamic drag because the vortices are aided by electrical attraction between charged particles carried in the exhaust gas and a gutter electrode 120 to hold the afterburner flame 106.

According to embodiments, a charge source 118 is configured to apply a majority charge to the exhaust gas or the fuel 112. For example, as shown in FIG. 2, the charge source can include a plurality of sharp projections forming a corona electrode in a portion of the fuel sprayer 110. A gutter electrode 120 is configured to attract the majority charge toward the gutter 114. The gutter 114 and the gutter electrode 120 can be electrically isolated from one another. An electrical isolation flange 122 can be configured to electrically insulate the exhaust pipe 104 from the gas turbine stage 108. Additionally or alternatively, the exhaust pipe 104 can be at least partially formed from a dielectric material. A fuel isolator 124 can be configured to electrically insulate the fuel sprayer 110 from the gas turbine 100.

A plurality of mounting rods 126 can be configured to support the fuel sprayer 110 and the gutter 114 from a turbine hub 128. Alternatively, the fuel sprayer 110 and the gutter 114 can be supported from the exhaust pipe 104. One or more mounting rod electrical insulators can be configured to electrically insulate the mounting rods 126 from the turbine hub 128. Additionally, one or more mounting rod electrical insulators 130 can be configured to electrically insulate the fuel sprayer 110, the gutter 114, and the charge source 118 from the mounting rods 126 and the turbine hub 128. The charge source 118 can take various forms.

The charge source 118 can include a high voltage wire configured to contact the sprayed fuel 112. An anvil 132 can be included and configured to deflect the sprayed fuel 112.

According to an embodiment, the anvil 132 can be configured to deflect the sprayed fuel 112. The charge source 118 and the anvil 132 can be combined. Additionally or alternatively, the charge source 118 and the anvil 132 can be formed contiguously.

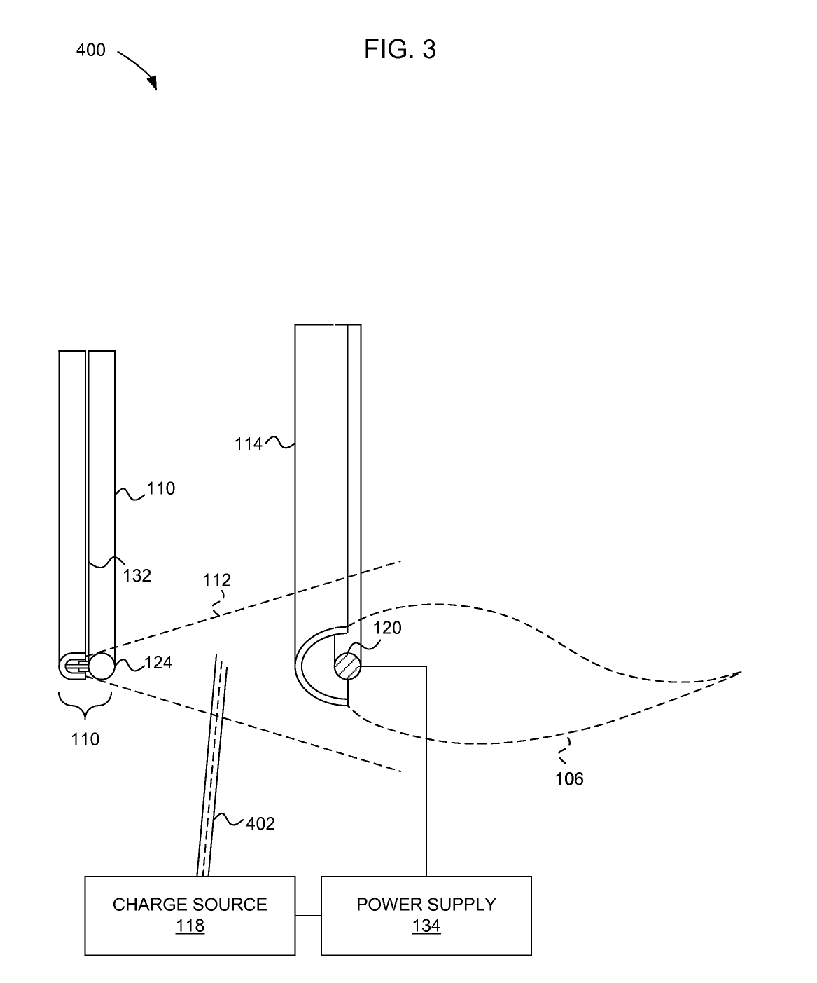

FIG. 3 is a diagram of an embodiment 300 of the gas turbine with afterburner 102 of FIGS. 1A and 1B wherein the charge source 118 includes a dielectric tube 302 aligned to convey charged air into the exhaust gas, according to an embodiment.

Referring to FIGS. 1-4, a power supply 134 can be included and configured to apply a high voltage to the charge source 118. The power supply 134 can be configured to output a voltage selected to cause plasma emissions to form along a portion of the fuel 112 and the exhaust gas 106 to the gutter electrode 120. The plasma emissions may continuously ignite an afterburner flame. Additionally or alternatively, the power supply 134 can be configured to output a voltage selected to cause a luminous emission along a portion of the fuel 112 and the exhaust gas 106 to the gutter electrode 120. The luminous emission may be associated with ignition of the exothermic reaction.

The power supply 134 can be configured to apply a voltage to the exhaust gas 106 to cause the gutter 114 to hold an afterburner flame in an exhaust gas stream 106 having a velocity greater than the flame propagation velocity along the exhaust gas stream 106 absent the gutter electrode 120.

The power supply 134 can be configured to apply an alternating current voltage and/or a time-varying voltage to the charge source 118. The time-varying voltage can include a periodic voltage waveform having a 50 to 10,000 Hertz frequency. According to another embodiment, the time-varying voltage can include a periodic voltage waveform having a 200 to 800 Hertz frequency. The time-varying voltage can include a square waveform, sine waveform, triangular waveform, truncated triangular waveform, sawtooth waveform, logarithmic waveform, and/or exponential waveform. The time-varying voltage can include a waveform having ±1000 volt to ±115,000 volt amplitude. According to another embodiment, the time-varying voltage can include a waveform having ±8000 volt to ±40,000 volt amplitude.

The power supply 134 can be configured to hold the gutter electrode 120 at a voltage different than the voltage applied to the charge source 118. The voltage source can be configured to apply a second time-varying voltage to the gutter electrode 120, the second time-varying voltage being opposite in sign to the time-varying voltage applied to the charge source 118.

The power supply 134 can be configured to hold the gutter electrode 120 substantially at voltage ground and/or can be at a voltage opposite in polarity to the voltage applied to the charge source 118. The gutter electrode 120 can be electrically isolated from ground and from voltages other than the voltage applied to the gutter electrode 120.

A flame detector may be included and configured to detect a presence of an afterburner flame by measuring a presence of the majority charge in a volume occupied by the afterburner flame. Additionally or alternatively, the flame detector can be configured to detect an absence of an afterburner flame by measuring an absence of the majority charge in a volume that would be occupied by the afterburner flame.

The charge source 118 and the gutter electrode 120 can be configured to cooperate to produce an ignition arc selected to maintain ignition of an afterburner flame.

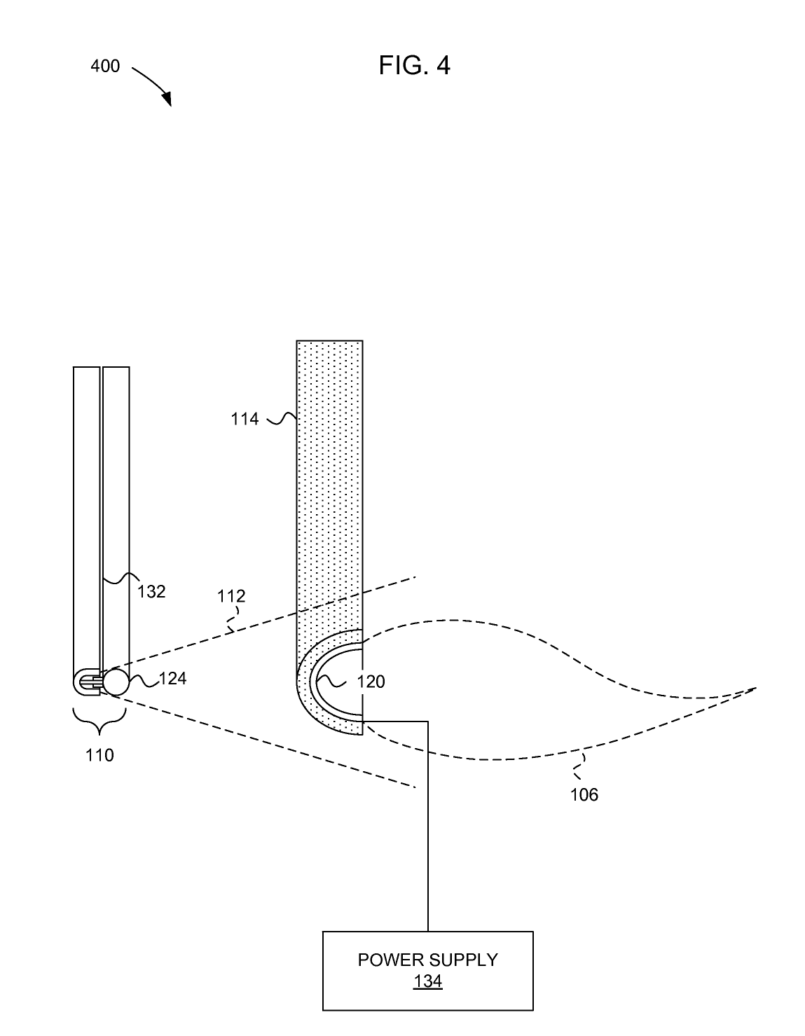

FIG. 4 shows an embodiment wherein the gutter 114 is formed from a dielectric material and the gutter electrode 120 is plated on a vacuum side of the gutter.

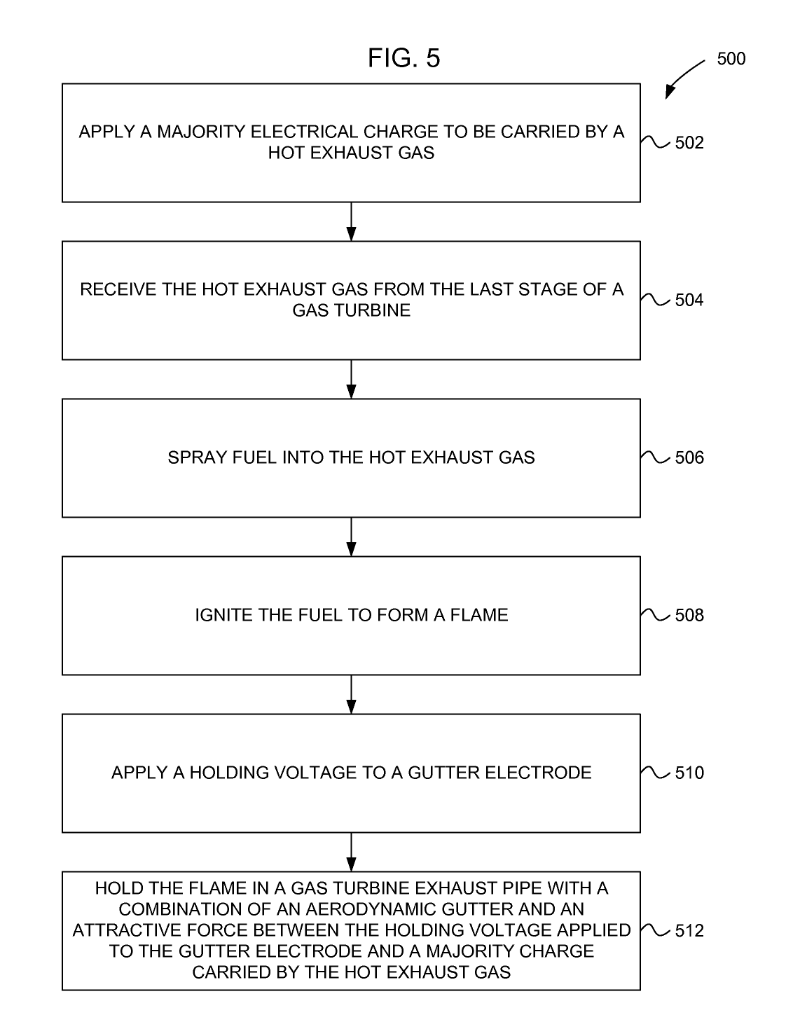

FIG. 5 is a flow chart showing a method 500 for using the gas turbine 100 with afterburner 102, according to an embodiment. In step 502 a majority electrical charge may be applied to be carried by a hot exhaust gas. The majority charge may be applied to a combustion reaction in a combustor.

In other words, the majority charge can be applied to a combustion reaction prior to flowing the combustion reaction toward a first stage of the gas turbine.

The majority electrical charge may be applied to the hot exhaust gas at a gas flow node arranged to receive the hot exhaust gas from the gas turbine. The majority electrical charge may be applied to the fuel, and/or may be applied to the exhaust gas. The majority charge may be applied in an exhaust pipe 104 aligned to receive exhaust gas 106 from a gas turbine stage 108.

In step 502 the charge source can include a high voltage wire contacting the sprayed fuel and/or an anvil that deflects the sprayed fuel. Step 502 can include flowing a charged fluid through a dielectric tube 202 aligned to convey the charged fluid into the exhaust gas.

Proceeding to step 504, the hot exhaust gas can be received from a gas turbine. Step 504 may include passing the hot combustion gas through at least one gas turbine stage and/or can include receiving the hot exhaust gas from the last stage of the turbine.

In step 506, fuel may be sprayed into the hot exhaust gas. Continuing to step 508, the fuel may be ignited to form a flame.

Proceeding to step 510, a holding voltage may be applied to a gutter electrode. In step 510, a voltage can be maintained to produce an ignition arc selected to maintain ignition of an afterburner flame between the hot exhaust gas majority charge and the gutter electrode.

In step 512 the flame may be held in a gas turbine exhaust pipe with a combination of an aerodynamic gutter and an attractive force between the holding voltage applied to the gutter electrode and a majority charge carried by the hot exhaust gas. Step 512 may include producing vortices with an aerodynamic bluff body and attracting the majority charge toward the gutter with a gutter electrode. Step 512 may include a cooperation between an aerodynamic gutter and a gutter electrode that are in electrical continuity with one another. The gutter electrode can include a conductive surface. The conductive surface can be electrically insulated and/or electrically isolated in intermittent electrical continuity with the (charged) hot exhaust gas (not shown).

The method 500 can include operating a power supply to apply a high voltage to the charge source (not shown). Step 512 may include outputting a voltage selected to cause plasma emissions to form along a portion of the fuel and the exhaust gas to the gutter electrode with the power supply. The plasma emissions may continuously ignite an afterburner flame (not shown). According to another embodiment, step 512 may include outputting a voltage selected to cause a luminous emission along a portion of the fuel and the exhaust gas proximate the gutter electrode. The luminous emission may continuously ignite an afterburner flame with (not shown).

Operating a power supply to apply a high voltage to the charge source may include applying an alternating current voltage, a time-varying voltage, and/or a periodic voltage waveform having a 50 to 10,000 Hertz frequency. According to another embodiment, a periodic voltage waveform having a 200 to 800 Hertz frequency may be applied. The time-varying voltage can include a square waveform, sine waveform, triangular waveform, truncated triangular waveform, sawtooth waveform, logarithmic waveform, and/or exponential waveform. The time-varying voltage can include a waveform having ±1000 volt to ±115,000 volt amplitude. According to another embodiment, the time-varying voltage can include a waveform having ±8000 volt to ±40,000 volt amplitude.

Operating a power supply to apply a high voltage to the charge source may include holding the gutter electrode at a voltage different than the voltage applied to the charge source and/or applying a second time-varying voltage to the gutter electrode, the second time-varying voltage being opposite in sign to the time-varying voltage applied to the charge source.

Operating a power supply to apply a high voltage to the charge source may include holding the gutter electrode substantially at voltage ground and/or at a voltage opposite in polarity to the voltage applied to the charge source. The gutter electrode can be electrically isolated from ground and from voltages other than the voltage applied to the gutter electrode and a voltage attributable to the majority charge.

A flame detector can be included and operated to detect a presence of an afterburner flame by measuring a presence of a flow of the majority charge in continuity with the gutter electrode.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

1. A gas turbine afterburner, comprising:
an exhaust pipe aligned to receive exhaust gas from a gas turbine stage;
a fuel sprayer configured to spray fuel into the exhaust gas;
a gutter configured as an aerodynamic bluff body to produce vortices in the exhaust gas;
a charge source configured to apply a majority charge to the exhaust gas or the fuel; and
a gutter electrode configured to attract the majority charge toward the gutter.

2. The gas turbine afterburner of claim 1, wherein the gutter and the gutter electrode are electrically isolated from one another.

3. The gas turbine afterburner of claim 1, wherein the gutter and/or the exhaust pipe is formed from a dielectric material.

4. The gas turbine afterburner of claim 1, further comprising: an electrical isolation flange configured to electrically insulate the exhaust pipe from the gas turbine stage.

5.-9. (canceled)

10. The gas turbine afterburner of claim 1, further comprising an anvil configured to deflect the sprayed fuel.

11.-13. (canceled)

14. The gas turbine afterburner of claim 1, wherein the gutter and the gutter electrode are in electrical continuity with one another.

15. The gas turbine afterburner of claim 1, further comprising: a power supply configured to apply a high voltage to the charge source.

16. The gas turbine afterburner of claim 15, wherein the power supply is configured to output a voltage selected to cause plasma emissions and/or a luminous emission to form along a portion of the fuel and the exhaust gas to the gutter electrode.

17.-21. (canceled)

22. The gas turbine afterburner of claim 15, wherein the power supply is configured to apply a periodic voltage to the charge source, where the periodic voltage is voltage relative to the gutter electrode.

23.-32. (canceled)

33. The gas turbine afterburner of claim 1, further comprising:
a flame detector configured to detect a presence of an afterburner flame by measuring a presence of the majority charge in a volume occupied by the afterburner flame.

34. (canceled)

35. The gas turbine afterburner of claim 15, wherein the charge source and the gutter electrode, and the high voltage, are configured to cooperate to produce an ignition arc selected to maintain ignition of an afterburner flame.

36. A method for operating a gas turbine afterburner, comprising:
applying a majority electrical charge to be carried by a hot exhaust gas;
receiving the hot exhaust gas from a gas turbine;
spraying fuel into the hot exhaust gas;
igniting the fuel to form a flame;
applying a holding voltage to a gutter electrode; and
holding the flame in a gas turbine exhaust pipe with a combination of an aerodynamic gutter and an attractive force between the holding voltage applied to the gutter electrode and a majority charge carried by the hot exhaust gas.

37.-41. (canceled)

42. The method for operating a gas turbine afterburner of claim 36, wherein applying the majority charge includes applying the majority charge to the exhaust gas or the fuel.

43.-47. (canceled)

48. The method for operating a gas turbine afterburner of claim 36, wherein applying a majority electrical charge to be carried by a hot exhaust gas with a charge source including an anvil that deflects the sprayed fuel.

49.-50. (canceled)

51. The method for operating a gas turbine afterburner of claim 36, further comprising: operating a power supply to apply a high voltage to the charge source.

52. The method for operating a gas turbine afterburner of claim 51, wherein holding the flame in a gas turbine exhaust pipe with a combination of an aerodynamic gutter and an attractive force between the holding voltage applied to the gutter electrode and a majority charge carried by the hot exhaust gas includes outputting a voltage selected to cause plasma emissions and/or luminous emission to form along a portion of the fuel and the exhaust gas to the gutter electrode with the power supply.

53. The method for operating a gas turbine afterburner of claim 52, further comprising:
continuously igniting an afterburner flame with the plasma emissions.

54.-56. (canceled)

57. The method for operating a gas turbine afterburner of claim 51, wherein operating a power supply to apply a high voltage to the charge source includes applying a periodic voltage to the charge source, where the periodic voltage is voltage relative to the gutter electrode.

58.-67. (canceled)

68. The method for operating a gas turbine afterburner of claim 36, further comprising:
operating a flame detector to detect a presence of an afterburner flame by measuring a presence of a flow of the majority charge in continuity with the gutter electrode.

69. The method for operating a gas turbine afterburner of claim 36, wherein applying a holding voltage to a gutter electrode includes maintaining a voltage to produce an ignition arc selected to maintain ignition of an afterburner flame between the hot exhaust gas majority charge and the gutter electrode.

70. The gas turbine afterburner of claim 1, wherein the gutter electrode is disposed within an afterburner flame and is held behind the gutter in a stream of the exhaust gas.

71. The gas turbine afterburner of claim 70, wherein, in a cross section, the gutter electrode is concentric with an inner surface of the gutter,
